(19) United States
(12) Patent Application Publication
(10) Pub. No.: US 2026/0226937 A1
(43) Pub. Date: Aug. 6, 2026

(54) DUAL LOCKING OF ROTATING SHAFT ASSEMBLY

(71) Applicant: SAAB AB, Linköping (SE)

(72) Inventor: Niklas BJÖRNEHÄLL, Bankeryd (SE)

(21) Appl. No.: 19/148,827

(22) PCT Filed: Jan. 8, 2024
(86) PCT No.: PCT/SE2024/050011

§ 371 Date: Jul. 17, 2025

(30) Foreign Application Priority Data
Jan. 30, 2023 (SE) 2300006-0

(51) Int. Cl. F16B 39/10

(52) U.S. Cl. CPC F16B 39/108; F16B 39/101; F16C 2226/60

(57) ABSTRACT

The invention relates to a locking arrangement (20) arranged to be mounted onto a rotating shaft (4). The locking arrangement (20) comprises a primary lock washer (7) comprising a plurality of foldable primary lock washer tabs (7a) arranged to be mounted innermost on the rotating shaft (4), a shaft nut (8) comprising a plurality of shaft nut tab grooves (8a) arranged to engage with a folded primary lock washer tab arranged to be mounted outside of the primary lock washer (7) onto the rotating shaft (4). The shaft nut (8) further comprises at least two shaft nut mounting threads (8b) and the locking arrangement (20) further comprises a secondary lock ring (9) arranged to be mounted outermost on the rotating shaft (4). The secondary lock ring (9) comprises a plurality of secondary lock ring mounting holes (9a) that can be aligned with the shaft nut mounting threads (8b) such that at least two attachment screws (10) can be mounted through both the secondary lock ring (9) and the shaft nut (8).

WO

### TECHNICAL FIELD

The invention relates to a locking arrangement arranged to be mounted onto a rotating shaft and a method for providing a locking arrangement onto a rotating shaft.

### BACKGROUND ART

In an actuation system, such as an actuation system for manoeuvring a flight control surface or a landing gear, the actuator in the actuation system is routinely exposed to high levels of pressure from torque, vibrations and environmental issues. As an actuation system is essential for manoeuvring, a failure during critical parts of a flight can have disastrous consequences.

An electric motor actuator (EMA) includes a few individual subassemblies where failure in one of the critical mechanical interfaces can lead to a catastrophic failure and break of the actuator.

There is thus a need for an improved locking device for a rotating shaft of an actuator.

### SUMMARY OF THE INVENTION

An objective of this disclosure is to provide a locking arrangement arranged to be mounted onto a rotating shaft and a method for providing a locking arrangement onto a rotating shaft that addresses the problems described above. This object is achieved by the technical features contained in the characterizing portion of independent claims 1 and 8. The dependent claims contain advantageous embodiments, further developments and variants of the method and system.

The invention relates to a locking arrangement arranged to be mounted onto a rotating shaft. The locking arrangement comprises a primary lock washer comprising a plurality of foldable primary lock washer tabs wherein the primary lock washer is arranged to be mounted innermost on the rotating shaft. The primary lock washer comprises a lock washer connector arranged to fit in a shaft connector of the rotating shaft. A shaft nut comprises a plurality of shaft nut tab grooves arranged to engage with a folded primary lock washer tab and is arranged to be mounted outside of the primary lock washer onto the rotating shaft. When the one or more primary lock washer tabs are folded down into the shaft nut tab grooves, the primary lock washer and the shaft nut are mechanically connected to the shaft. The shaft nut further comprises at least two shaft nut mounting threads and the locking arrangement further comprises a secondary lock ring arranged to be mounted outermost on the rotating shaft. The secondary lock ring comprises a plurality of secondary lock ring mounting holes and a secondary lock ring connector arranged to fit in the shaft connector of the rotating shaft, such that at least two secondary lock ring mounting holes always align with the at least two shaft nut mounting threads such that at least two attachment screws can be mounted through both the secondary lock ring and the shaft nut.

A locking device according to the invention is able to cope with the pressures exerted on it and is able to handle component tolerances with greater margins while maintaining desired operational characteristics.

The actual mechanical interface fulfil environmental requirements together with requirement according to European Union Aviation Safety Agency/Federal Aviation Administration (EASA/FAA) for dual geometric locking, specifically CS 25.607/AC 25.607 Fasteners.

The EMA becomes more reliable and the mean time between failures (MTBF) is increased. No special design regarding locking is required on the rotating shaft.

The invention leads to that dual locking is achieved with separate parts. The cost for spare parts can be minimized since no special design of e.g. the rotating shaft is needed. This can enable alternative suppliers to secure low cost and reduced lead times for mechanical parts.

The shaft nut may be a lock nut for a ball screw or a lead screw or an attachment nut for sensor parts that are attached to a rotating shaft, such as an attachment nut for a resolver.

The dual locking principle can be incorporated in various designs where a secure interface is needed, such as for instance ball screws, lead screws, or a shaft comprising a resolver. The same processes in e.g. component maintenance manuals (CMM:s) will optimize maintenance work and cost for the customer.

For instance, EMAs with ball screw connections having a locking device according to the invention will be advantageously used as a control means within many areas, such as for instance control surfaces, landing gears, cargo doors, robots, missiles, throttle actuators etc.

The secondary lock ring further comprises a secondary lock ring connector arranged to fit in a shaft key connector of the rotating shaft.

This ensures an easy aligning of the secondary lock ring to the primary lock washer and shaft nut and ensures that the shaft and shaft nut are mechanically connected. Preferably, but not necessarily a standard shaft key groove can be used as a shaft connector for both the primary lock washer and secondary lock ring. Other alternatives for a shaft connector to the standard shaft key groove are possible within the scope of the invention, such as for instance a plane face arranged on the shaft. Connectors on the primary lock washer, secondary lock ring and possibly also the shaft nut are in such case adapted accordingly. The design of connectors for shafts and lock washers are well known in the art.

The secondary lock ring may be made of aluminium and the attachment screws are made of steel. These materials provide suitable material characteristics for the secondary lock ring and the attachment screws. In low-stress applications, the secondary lock ring and attachment screws can be made of other materials with less strength, such as for instance plastics.

The primary lock washer tabs may be pre-folded. This makes locking of the primary lock washer generally easier and also makes it possible to use the primary lock washer in applications where there is not much space to interact with the primary lock washer tabs. Thus, minimal radial access is required.

The invention also relates to a shaft arrangement comprising a rotating shaft and a locking arrangement according to the above description. As mentioned above, a shaft arrangement using a locking arrangement according to the above description will fulfil the environmental requirements together with requirement according to European Union Aviation Safety Agency/Federal Aviation Administration (EASA/FAA) for dual geometric locking, specifically CS 25.607/AC 25.607 Fasteners.

The invention also relates to a method for mounting a locking arrangement onto a rotating shaft. The locking arrangement comprises a primary lock washer comprising a plurality of foldable primary lock washer tabs and a lock washer connector arranged to fit in a shaft connector of the rotating shaft, a shaft nut comprising a plurality of shaft nut tab grooves and at least two shaft nut mounting threads, and a secondary lock ring comprising a plurality of secondary lock ring mounting holes. The method comprises:
Arranging a rotating shaft with one end of the rotating shaft arranged in a bearing interface,
Attaching the primary lock washer to the rotating shaft by aligning a primary lock washer connector into a shaft connector arranged on the end of the rotating shaft,
Attaching a shaft nut to the rotating shaft and tightening the shaft nut to applicable shaft nut mounting torque,

Folding down at least one primary lock washer tab into a shaft nut tab groove, thereby mechanically connecting the primary lock washer and the shaft nut to the shaft,
Attaching the secondary lock ring to the rotating shaft by aligning a secondary lock ring connector with the shaft connector, thereby aligning at least two secondary lock ring mounting holes (9a) with the at least two shaft nut mounting threads (8b),
Mounting at least two attachment screws through the secondary lock ring mounting holes and shaft nut mounting threads,
Tightening the at least two attachment screws to an attachment screw mounting torque.

The method provides an easy way to mount the locking arrangement onto a rotating shaft.

The method may further comprise:
Arranging the number of secondary lock ring mounting holes to match with positions of shaft nut mounting threads.

The locking arrangement is designed as a whole, leading to that the number of secondary lock ring mounting holes are designed dependent on the number of shaft nut mounting threads. In this way the positions of the shaft nut mounting threads on the shaft nut will always have corresponding secondary lock ring mounting holes that the attachment screws can be mounted into to lock the two together.

### BRIEF DESCRIPTION OF THE DRAWINGS

FIG. 1 schematically shows a shaft arrangement comprising a prior art locking arrangement for a rotating shaft in an exploded view,

FIG. 2 schematically shows a shaft arrangement with the prior art locking arrangement for a rotating shaft assembled,

FIG. 3 schematically shows a shaft arrangement comprising a locking arrangement for a rotating shaft according to the invention in an exploded view,

FIG. 4 schematically shows a shaft arrangement comprising a locking arrangement for a rotating shaft according to the invention assembled,

FIG. 5 schematically shows the separate parts of the locking arrangement according to the invention in an exploded view,

FIG. 6 schematically shows a cross-sectional view of a rotating shaft comprising a locking arrangement according to the invention,

FIG. 7 shows a flow chart of the method for providing a locking arrangement onto a rotating shaft,

FIGS. 8a-8e schematically shows one example embodiment of a geometric relation between the various parts of the locking arrangement.

FIGS. 9a-9b schematically show a completed locking arrangement 20 with a configuration according to the geometric relation according to FIGS. 8a-8e.

### DETAILED DESCRIPTION

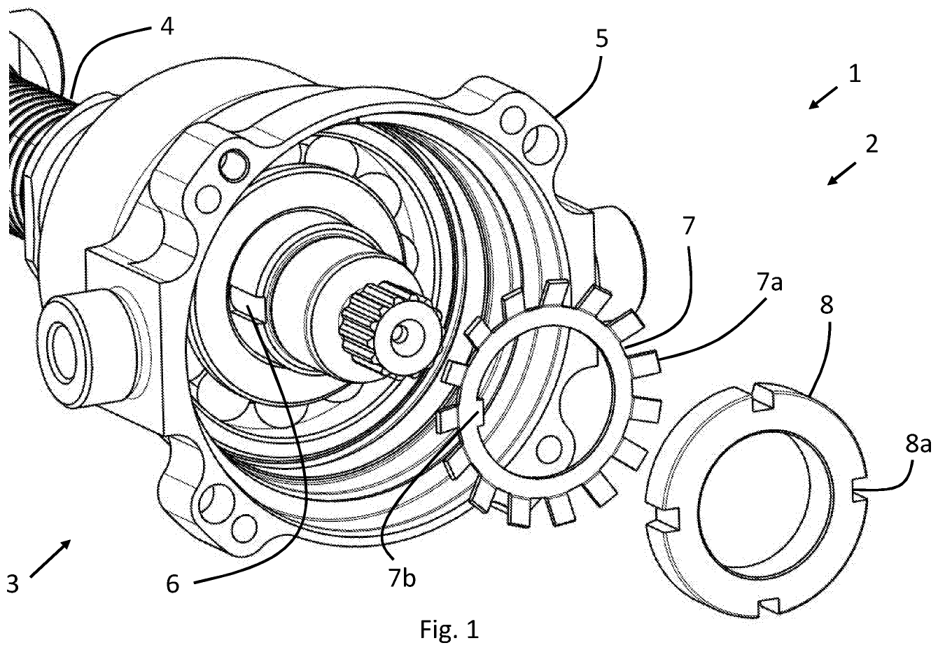

FIG. 1 schematically shows a shaft arrangement 1 comprising a prior art locking arrangement 2 for a rotating shaft 3 in an exploded view. FIG. 1 shows an end part 3 of a rotating shaft 4, in this example embodiment a ball screw. The rotating shaft 4 of the ball screw is mounted in a housing 5, in this example a ball screw housing. The rotating shaft 4 of the ball screw comprises a shaft key groove 6. The prior art locking arrangement 2 comprises a lock washer 7 and a shaft nut 8 that are mounted onto the rotating shaft 4 in order to ensure that the rotating shaft 4 will not continue to rotate if the rotating shaft 4 for some reason fails.

One or more lock washer tabs 7a are folded in the direction of the shaft nut 8 that comprises a plurality of shaft nut tab grooves 8a. The shaft nut tab grooves 8a are arranged to engage with the one or more folded primary lock washer tabs 7a to provide a mechanical locking effect between the two. The number of lock washer tabs 7a to be folded down is decided by the design of the lock washer 7. The rotating shaft 4 comprises a shaft connector in the form of a shaft key groove 6 and the lock washer 7 comprises a lock washer connector in the form of a lock washer key groove flange 7b such that when the one or more primary lock washer tabs 7a are folded down into the shaft nut tab grooves 8a, the primary lock washer 7 and the shaft nut are mechanically connected to the shaft 4.

However, it has been shown that this prior art locking arrangement 2 does not provide a mechanical locking effect that withstands the forces encountered in all applications. This leads to a risk of catastrophic failure in high-force applications.

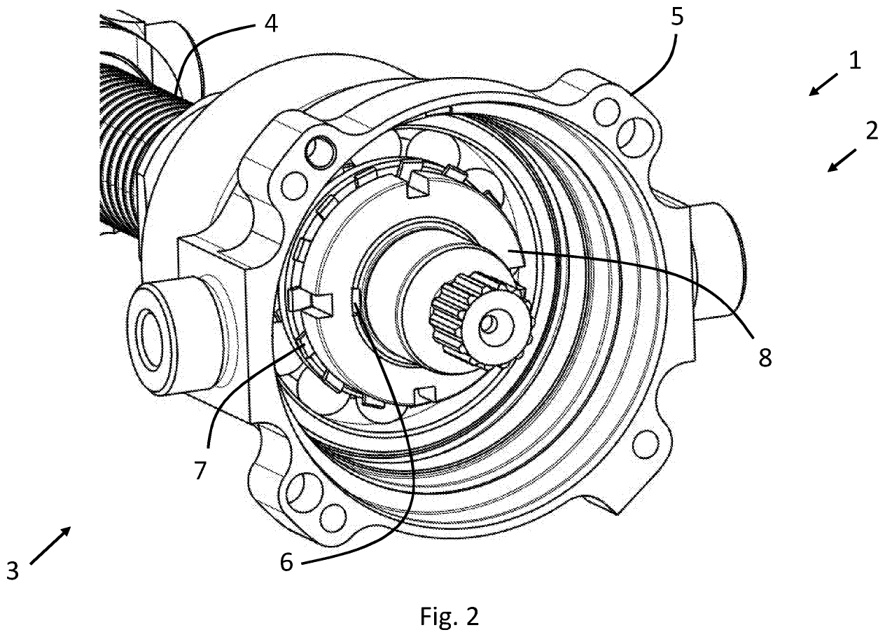

FIG. 2 schematically shows the shaft arrangement 1 of FIG. 1 with the prior art locking arrangement 2 for a rotating shaft 4 assembled onto the rotating shaft 4.

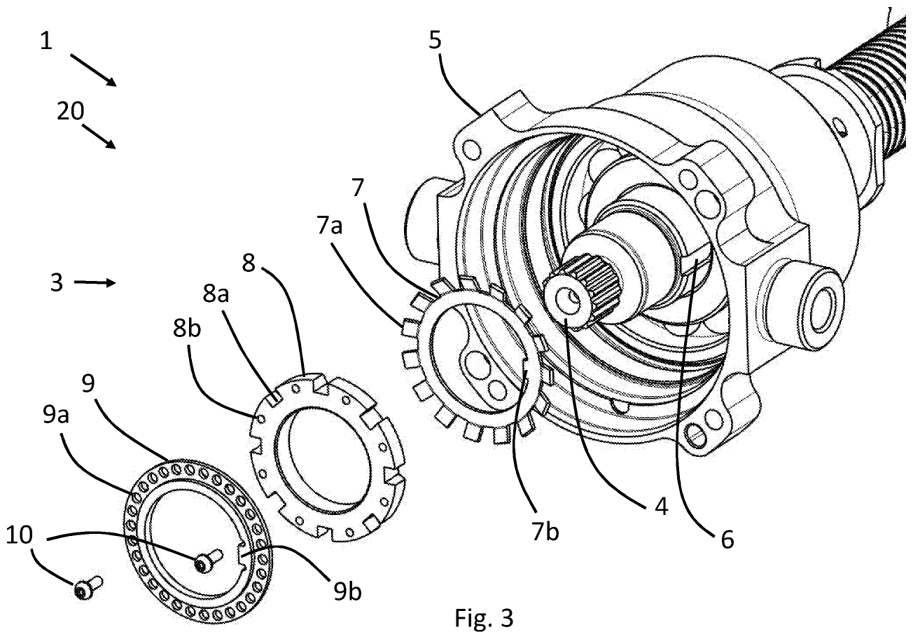

FIG. 3 schematically shows a shaft arrangement 1 comprising a locking arrangement 20 for a rotating shaft 4 according to the invention in an exploded view. Similar to FIG. 1, FIG. 3 shows an end part 3 of a rotating shaft 4, in this example embodiment a ball screw. The same reference numbers are used for the same features as in FIG. 1.

A locking arrangement 20 according to the invention in an exploded view comprises apart from a primary lock washer 7 (identical to the prior art lock washer 7 of FIG. 1), a shaft nut 8 comprising at least two shaft nut mounting threads 8b and a secondary lock ring 9 comprising a plurality of secondary lock ring mounting holes 9a. Providing shaft nut mounting threads 8b on the shaft nut 8 makes it possible to obtain an increased locking effect by the use of a secondary lock ring 9. The primary lock washer 7, the shaft nut 8 and the secondary lock ring 9 of the locking arrangement 20 are designed together, such that a geometric relationship between the number of lock washer tabs 7a, the number of tab grooves 8a, the number of mounting threads 8b, and the number of mounting holes 9a is created. This relationship ensures that when the locking arrangement 20 is assembled, at least two of the secondary lock ring mounting holes 9a always align with at least two of the shaft nut mounting threads 8b. In this way, at least two attachment screws 10 can always be mounted through both the secondary lock ring 9 and the shaft nut 8 to obtain a mechanical locking effect between the two. By geometric relationship is meant that having as an example a primary lock washer 7 comprising a certain number of circumferentially equally distributed lock washer tabs 7a, the number of circumferentially equally distributed tab grooves 8a and the number of circumferentially equally distributed mounting threads 8b on the shaft nut 8, and the number of circumferentially equally distributed mounting holes 9a on the secondary lock ring are adapted such that at least two of the secondary lock ring mounting holes 9a always align with at least two of the shaft nut mounting threads 8b.

It is possible to design the shaft nut 8 and the secondary lock ring 9 such that more than two secondary lock ring mounting holes 9a always align with corresponding shaft nut mounting threads 8b on the shaft nut 8 such as three, four, five etc. attachment screws 10 can be mounted through both the secondary lock ring 9 and the shaft nut 8 to obtain an even stronger mechanical locking effect between the two. When using two attachment screws 10, the attachment screws 10 are preferably aligned such that they are mounted on essentially diametrically opposite sides of the locking arrangement 20 in order to obtain a force equilibrium. With higher number of attachment screws 10, the attachment screws 10 preferably align such that they are mounted in a pattern such that a force equilibrium is obtained. For three attachment screws 10 this would be an equilateral triangle, for four attachment screws 10 a square, for five attachment screws 10 a pentagon, etc.

An additional advantage with the locking arrangement 20 according to the invention is that it can handle component tolerances with greater margins. The primary lock washer 7 is also designed together with the shaft nut 8 and the secondary lock ring 9 to ensure that all three parts 7, 8, 9 form the locking arrangement 20 together.

The secondary lock ring 9 is arranged to be mounted outermost on the rotating shaft 4 with the primary lock washer 7 mounted innermost on the rotating shaft 4 and the shaft nut 8 mounted between the primary lock washer 7 and the secondary lock ring 9. The primary lock ring washer tabs 7a are folded into the shaft nut tab grooves 8a as explained above.

In FIG. 3, the secondary lock ring 9 further comprises a secondary lock ring connector in the form of a secondary lock ring key groove flange 9b arranged to fit in the shaft key groove 6 of the rotating shaft 4. This ensures an easy fit of the secondary lock ring 9 onto the rotating shaft 4 and provides additional mechanical connection between the shaft 4 and the shaft nut 8.

As mentioned above, the key groove flange 6 can be replaced by another type of connector such as a for instance a plane surface of the shaft 6. Connectors 7a and 9b on the primary lock washer 7 and the secondary lock ring 9 respectively are in such case adapted accordingly.

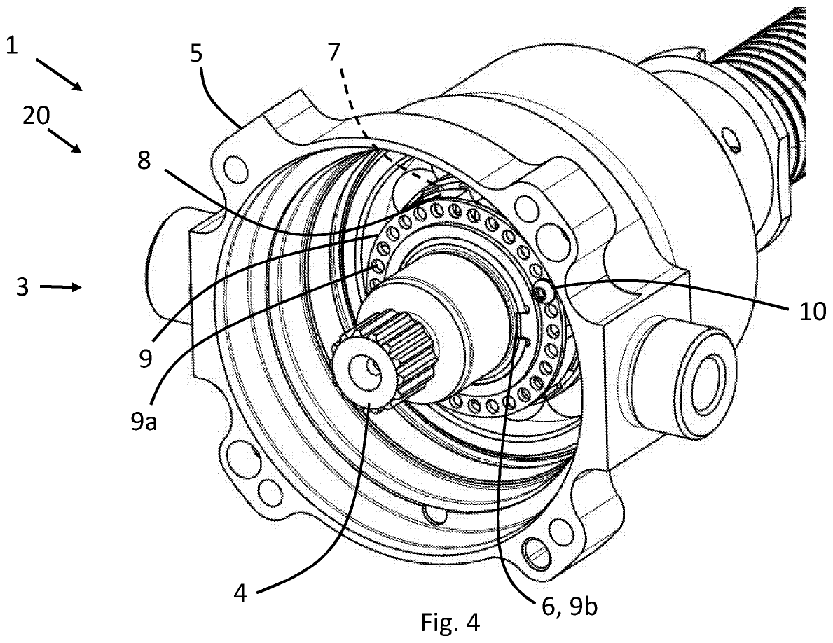

FIG. 4 schematically shows a shaft arrangement 1 comprising a locking arrangement 20 for a rotating shaft 4 according to the invention with the locking arrangement 20 assembled onto the rotating shaft 4. The secondary lock ring 9 and one of the two attachment screws 10 are visible in FIG. 4.

The threads 8b are designed with thread locking inserts which secure locking of the attachment screws 10.

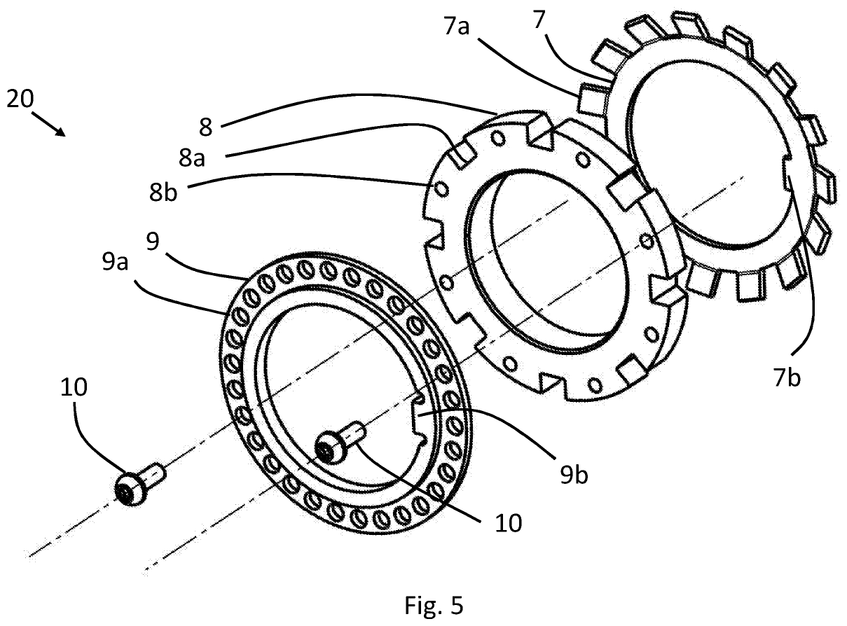

FIG. 5 schematically shows the separate parts of the locking arrangement 20 according to the invention in an exploded view. In FIG. 5, dash-dotted lines show how the attachment screws 10 can be mounted through both the secondary lock ring 9 and the shaft nut 8 to obtain a mechanical locking effect between the two. FIG. 5 clearly shows the alignment between two secondary lock ring mounting holes 9a and two of the shaft nut mounting threads 8b.

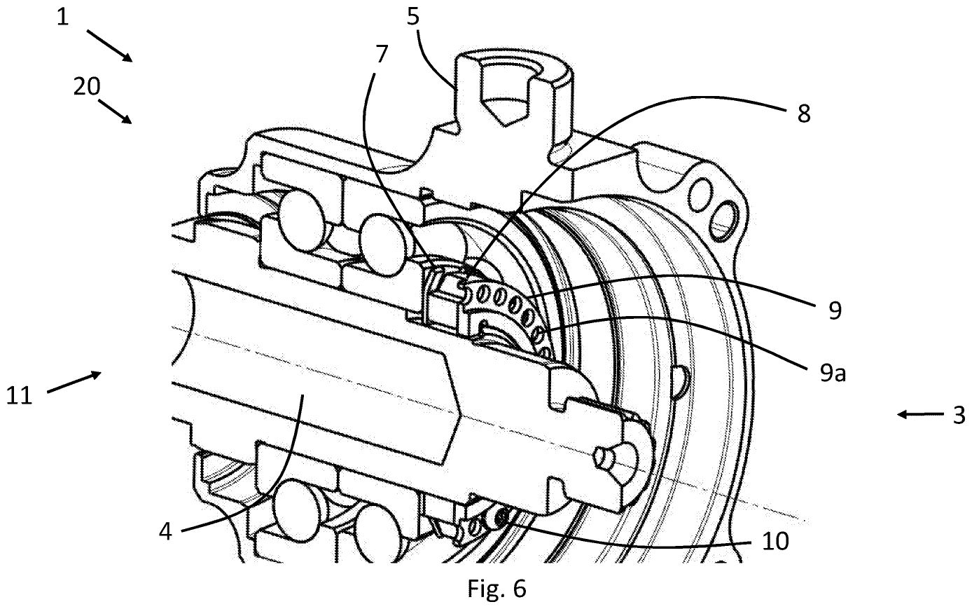

FIG. 6 schematically shows a cross-sectional view of a rotating shaft 4 comprising a locking arrangement 20 according to the invention. In FIG. 6, the inner parts 11 of the housing 5 are shown. These parts are all known in the art, meaning that the locking arrangement 20 can be used with a standard ball screw or other types of similar screws such as lead screws or on shafts with an attachment nut, for instance for a resolver.

In FIG. 6, the mounted locking arrangement 20 according to the invention can be seen with one of the attachment screws 10 visible. It can be seen that the locking arrangement 20 provides an excellent locking of the ball screw housing 5, thereby preventing failure of the ball screw.

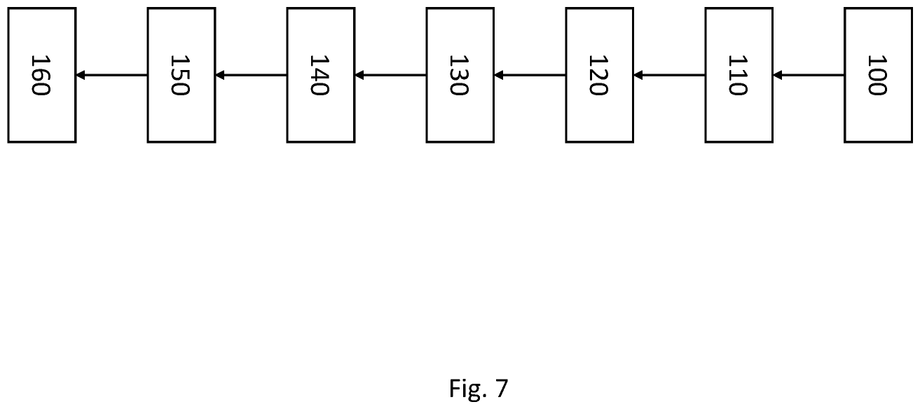

FIG. 7 shows a flow chart of the method for providing a locking arrangement 20 onto a rotating shaft 4. In box 100, a rotating shaft 4 is arranged with one end of the rotating shaft 4 arranged in a bearing interface. In box 110, the primary lock washer 7 is attached to the rotating shaft 4 by aligning a primary lock washer key groove flange (or plane surface) into a shaft key groove 6 (or plane surface on the shaft) arranged on the end of the rotating shaft 4. In box 120, a shaft nut 8 is attached to the rotating shaft 4 and the shaft nut 8 is tightened to an applicable shaft nut mounting torque. In box 130, at least one primary lock washer tab is folded down into a corresponding shaft nut tab groove on the shaft nut 8. In box 140, the secondary lock ring 9 is attached to the rotating shaft 4. If the secondary lock ring 9 comprises a secondary lock ring key groove flange, it is aligned with the shaft key groove 6. In box 150, at least two attachment screws 10 are mounted through the secondary lock ring mounting holes 9a and shaft nut mounting threads 8b. In box 160, the at least two attachment screws 10 are tightened to an attachment screw mounting torque. The locking arrangement 20 is now mounted and secured onto the rotating shaft 4.

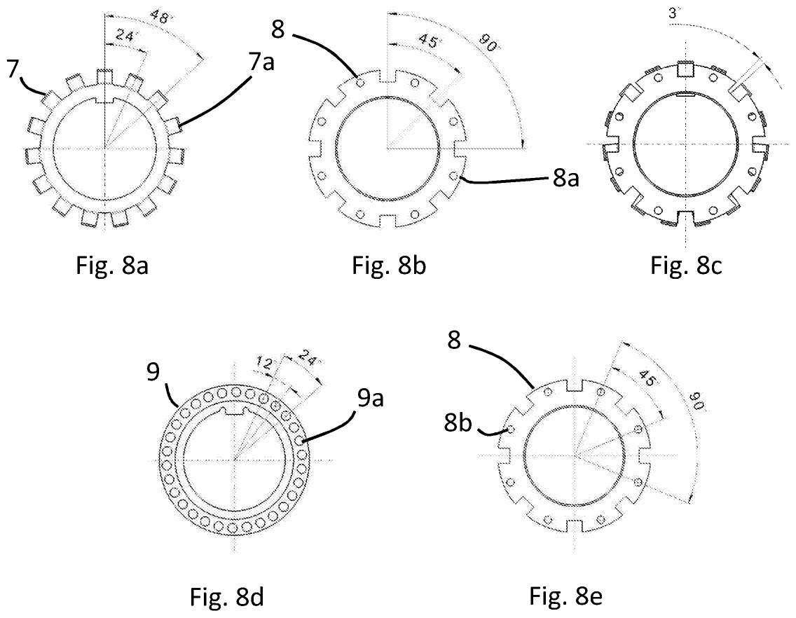

FIGS. 8a-8f schematically shows one example embodiment of a geometric relation between the various parts of the locking arrangement.

FIG. 8a shows a primary lock washer 7 with fifteen lock washer tabs 7a arranged circumferentially, leading to a separation between two adjacent lock washer tabs of 24° (as measured from a midpoint of the lock washer tabs 7a). The separation between two non-adjacent lock washer tabs 7a with one lock washer tab 7a in between them is 48° (as measured from a midpoint of the lock washer tabs 7a).

FIG. 8b shows a shaft nut 8 comprising eight shaft nut tab grooves 8a, leading to a separation between two adjacent shaft nut tab grooves 8a of 45° (as measured from a midpoint of the shaft nut tab grooves 8a). The separation between two non-adjacent shaft nut tab grooves 8a with one shaft nut tab groove 8a in between them is 90° (as measured from a midpoint of shaft nut tab groove 8a).

FIG. 8d shows a secondary lock ring 9 comprising thirty secondary lock ring mounting holes 9a, leading to a separation between two adjacent secondary lock ring mounting holes 9a of 12° (as measured from a midpoint of the secondary lock ring mounting holes 9a). The separation between two non-adjacent secondary lock ring mounting holes 9a with one secondary lock ring mounting holes 9a in between them is 24° (as measured from a midpoint of the secondary lock ring mounting holes 9a).

FIG. 8e shows a shaft nut 8 comprising eight shaft nut mounting threads 8b, leading to a separation between two adjacent shaft nut mounting threads 8b of 45° (as measured from a midpoint of the shaft nut mounting threads 8b). The separation between two non-adjacent shaft nut mounting threads 8b with one shaft nut mounting thread 8b in between them is 90° (as measured from a midpoint of shaft nut mounting threads 8b).

From FIGS. 8a and 8b it is shown that a minimum rotation of the shaft nut 8 for the lock washer tabs 7a to be able to fit in the shaft nut tab grooves 8a is 2*24°−45°=3°. This is shown in FIG. 8c.

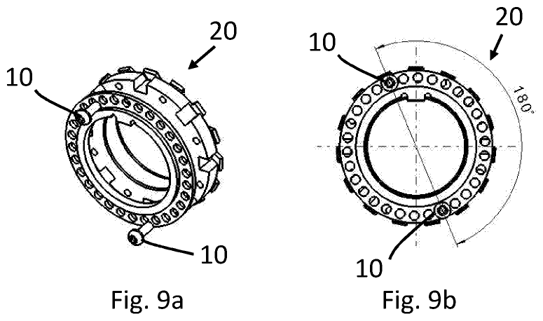

Further, the geometric relationship between number of mounting threads 8b in FIG. 8d and the number of mounting holes 9a in FIG. 8c ensure that exactly two opposite attachment screws 10 can be attached to the shaft nut for every 3° rotation of the shaft nut. This is illustrated in FIGS. 9a and 9b.

With different adaptations of the angles of FIGS. 8a, 8b, 8d and 8e similar geometric relationships can be made for locking arrangements 20 where three, four, five etc. attachment screws 10 are desired or required with circumferential separation of the attachment screws of 120°, 90°, 72° etc.

A shaft arrangement 1 comprising a locking arrangement 20 according to the invention complies with Certification Specifications and Acceptable Means of Compliance for large Aeroplanes, CS-25, produced by European Aviation Safety Agency (EASA) which is commonly referred in specifications by aerospace customers. CS-25 is fully equivalent with Federal Aviation Administration (FAA) Certification of Transport Airplane Structure, AC-25. (CS 25.607/AC 25.607).

As will be realised, the described locking arrangement 20 and method are capable of modification in various obvious respects, all without departing from the scope of the appended claims. Accordingly, the drawings and the description are to be regarded as illustrative in nature, and not restrictive.

1-9. (canceled)

10. A locking arrangement (20) arranged to be mounted onto a rotating shaft (4), the locking arrangement (20) comprising:
a primary lock washer (7) comprising a plurality of foldable primary lock washer tabs (7a), the primary lock washer (7) being arranged to be mounted innermost on the rotating shaft (4), wherein the primary lock washer (7) comprises a lock washer connector (7b) arranged to fit in a shaft connector (6) of the rotating shaft (4),
a shaft nut (8) comprising a plurality of shaft nut tab grooves (8a) arranged to engage with a folded primary lock washer tab (7a) arranged to be mounted outside of the primary lock washer (7) onto the rotating shaft (4), wherein when the one or more primary lock washer tabs (7a) are folded down into the shaft nut tab grooves (8a), the primary lock washer (7) and the shaft nut (8) are mechanically connected to the shaft (4), wherein the shaft nut (8) further comprises at least two shaft nut mounting threads (8b), and
a secondary lock ring (9) arranged to be mounted outermost on the rotating shaft (4), wherein the secondary lock ring (9) comprises a plurality of secondary lock ring mounting holes (9a) and a secondary lock ring connector (9b) arranged to fit in the shaft connector (6) of the rotating shaft (4), such that at least two secondary lock ring mounting holes (9a) always align with the at least two shaft nut mounting threads (8b) such that at least two attachment screws (10) can be mounted through both the secondary lock ring (9) and the shaft nut (8).

11. Locking arrangement (20) according to claim 10, wherein the shaft nut (8) is a lock nut for a ball screw.

12. Locking arrangement (20) according to claim 10, wherein the shaft nut (8) is a lock nut for a lead screw.

13. Locking arrangement (20) according to claim 10, wherein the shaft nut (8) is an attachment nut for a resolver.

14. Locking arrangement (20) according to claim 10, wherein the secondary lock ring (9) is made of aluminium and the attachment screws (10) are made of steel.

15. Locking arrangement (20) according to claim 10, wherein the primary lock washer tabs (7a) are pre-folded.

16. Shaft arrangement (1) comprising a rotating shaft (4) and a locking arrangement (20) according to claim 10.

17. Method for mounting a locking arrangement (20) onto a rotating shaft (4), wherein the locking arrangement (20) comprises a primary lock washer 7 comprising a plurality of foldable primary lock washer tabs (7a), and a lock washer connector (7b) arranged to fit in a shaft connector (6) of the rotating shaft (4)a shaft nut (8) comprising a plurality of shaft nut tab grooves (8a) and at least two shaft nut mounting threads (8b) and a secondary lock ring (9) comprising a plurality of secondary lock ring mounting holes (9a), wherein the method comprises:
arranging a rotating shaft (4) with one end of the rotating shaft (4) arranged in a bearing interface,
attaching the primary lock washer (7) to the rotating shaft (4) by aligning a primary lock washer connector (7b) with a shaft connector (6) arranged on the end of the rotating shaft (4),
attaching a shaft nut (8) to the rotating shaft (4) and tightening the shaft nut (8) to applicable shaft nut mounting torque,
folding down at least one primary lock washer tab (7a) into a shaft nut tab groove (8a), thereby mechanically connecting the primary lock washer (7) and the shaft nut (8) to the shaft (4),
attaching the secondary lock ring (9) to the rotating shaft (4) by aligning a secondary lock ring connector (9b) with a shaft connector (6), thereby aligning at least two secondary lock ring mounting holes (9a) with the at least two shaft nut mounting threads (8b),
mounting at least two attachment screws (10) through the secondary lock ring mounting holes (9a) and shaft nut mounting threads (8b), and
tightening the at least two attachment screws (10) to an attachment screw mounting torque.

18. Method according to claim 17, wherein the method further comprises arranging the number of secondary lock ring mounting holes (9a) to match with positions of shaft nut mounting threads (8b).
